(19) United States
(12) Patent Application Publication
(10) Pub. No.: US 2005/0125408 A1
(43) Pub. Date: Jun. 9, 2005

(54) Listing service tracking system and method for tracking a user's interaction with a listing service

(76) Inventors: Beena Somaroo, Ledgewood, NY (US); Maxwell Knight, New York, NY (US)

Correspondence Address: James J. DeCarlo;Stroock & Stroock & Lavan LLP, 180 Maiden Lane, New York, NY, 10038, US

(21) Appl. No.: 10/718,869

(22) Filed: Nov. 20, 2003

(51) Int. Cl. G06F 7/00; G06F 17/30; G06F 3/00; G06F 9/00; G06F 17/00; G06F 15/16

(52) U.S. Cl. 707/10; 715/760; 709/203

(57) ABSTRACT

A listing service tracking system and method for tracking a user's interaction with a listing service operates on a core tracking platform that utilizes a “lead” based concept to allow a user to efficiently and concurrently manage a large number of different leads initiated on one or more listing services. In an exemplary embodiment, the core listing service tracking platform is a software application that can be adapted to track a user's interaction with various types of listing services and to communicate with and integrate various types of ancillary services, such as e-mail, calendar systems, alerts systems, and the like.

### BACKGROUND OF THE INVENTION

1. Field of the Invention

The present invention is related to the field of Internet or web-based listing services and, in particular, to a system and method for tracking a user's interaction with such listing services.

2. Description of Related Art

Various services allow people or entities to post (i) items for sale, (ii) personal ads, (iii) employment opportunities, (iv) new and used car listings, (v) real estate listings, (vi) auction items, and the like. Traditionally, such listings were found in print media such as magazines and newspapers. More recently, however, such listings can be found on the world wide web or Internet and other online networks. Yahoo!®, for instance, operates several listing services, such as Yahoo!® Auctions, Yahoo!® Personals, Hot Jobs®, Yahoo!® Real Estate, and Yahoo!® Autos, to name a few. Each of these services permit users to view listings and initiate various actions, for example, to purchase goods, bid on an auction, meet other people, search for a job, or inquire about a used car.

Such online listing services provide various tools for permitting users to search the listings, browse through categorized listings, compare listings, and otherwise interact with and respond to listings. Presently, however, such services provide limited tools to enable the user to track their progress as they interact with one or more of the listings. Thus, to use a job search as an example, a user who initiates several job leads may quickly become overwhelmed with the number of contacts and calendar events. Consequently, users may miss various opportunities to enhance their job search, such as by following-up with prospective employers. Moreover, because some job leads may lie dormant for weeks or even months, the user may forget which jobs she applied for, one or more of the job descriptions or that she even applied for a particular job.

The systems managing a user's interactions with a listing service that do exist, such as Yahoo!® Auctions' Seller's Manager and Yahoo!® My Auctions, which both track a user's auction activity are limited in scope and functionality. First, these services fail to leverage ancillary services that may be provided by the auction listing service to enhance the user's ability to manage multiple actions. Moreover, such services are presently limited for use with auctions and are not useable with other types of listing services. Further such services are designed to operate with a single listing service. Thus, such listing services fail to harvest a wealth of information related to a user's interactions with listing services. Information that could be used enhance a user's interaction with a particular web site and, therefore, retain the user's interest may be lost.

Furthermore, it is well known that Internet or Web based service companies earn significant revenue by simply keeping users at their websites. Revenue may be generated in many ways, including but not limited to: (1) increasing user retention resulting in increased revenue from advertising, which may be enhanced when advertisers believe that ads can be targeted to users based on their interests and needs, and (2) increasing revenue by offering premium services to users of a site's basic, free services. Yahoo!® presently offers fee-based premium services under its Platinum and Premium Services brands. Getting users to utilize these fee-based services by leveraging free services is also an important goal of such companies.

Therefore, a need exists for a comprehensive, scalable, and portable listing service tracking system and method capable of tracking various user leads.

Furthermore, a need exists for a platform level system that ties together various ancillary value-added services, increases user retention, and promotes the leveraging of free services into fee-based services.

### SUMMARY OF THE INVENTION

The foregoing as well as other needs are satisfied by the present invention. A listing service tracking system and method that integrates one or more online services and enables end users to manage their responses to and interactions with one or more listings on various listing services.

According to an exemplary embodiment of the present invention, a listing service tracking system and method for tracking a user's interaction with a listing service operates on a core tracking platform that utilizes a “lead” based concept to allow a user to efficiently and concurrently manage a large number of different leads initiated on one or more listing services. The core listing service tracking platform is a software application that can be adapted to track a user's interaction with various types of listing services and to communicate with various types of ancillary services.

Exemplary embodiments of the listing service tracking system may integrate various ancillary electronic services to provide a comprehensive tool through which end users can manage their interactions with various listing services. By way of example, the listing service tracking system could integrate electronic services such as electronic mail (“e-mail”), electronic messaging (e.g., voice messaging via wireless devices and/or instant messaging), calendaring/scheduling programs, electronic address books, and other related services.

Furthermore, exemplary embodiments of the listing service tracking system may be capable of communicating with various types of electronic devices, such as personal digital assistants (“PDAs”), wireless telephones, mobile computers, tablet pc's, and other electronic computing devices. Such capability advantageously provides portability to the tracking system and permits the user to manage and track leads even when he/she is away from their primary computer. Thus, for example, if the user receives an urgent message from a prospective employer, the tracking system will preferably be capable of forwarding that message to one or more designated portable devices so that the user receives the message in relatively quickly.

Moreover, exemplary embodiments of the listing service tracking system may be coupled to advertising systems in which information from the tracking system is used to target advertisements to the end user. Information gathered from a user's interactions with a particular listing service could be used to target ads to that user. Thus, for instance, if a user has initiated one or more inquiries on Yahoo!® Autos for the purchase of a used car, that information can be forwarded to an advertising system that will cue up and serve advertisements related to the sale of used cars or related services, such as insurance and financing, to name a few. The information could also be used to target other services to the user, such as auto reviews, forums related to the particular car that was inquired about.

Other features of the present invention will become apparent from the following detailed description, considered in conjunction with the accompanying drawing figures. It is to be understood, however, that the drawings are designed solely for the purpose of illustration and not as a definition of the limits of the invention, for which reference should be made to the appended claims. Further, it will be clear to those of skill in the art that various modifications, additions, and subtractions can be made without departing from the spirit or scope of the claims.

### BRIEF DESCRIPTION OF THE DRAWINGS

In the drawing figures, which are merely illustrative, and wherein like reference characters denote similar elements throughout the several views:

FIG. 1 is a data flow diagram depicting an exemplary embodiment of lead record and action record creation, and integration of ancillary services;

FIG. 2 is a schematic overview of the system architecture of a first exemplary embodiment of the present invention;

FIG. 3 is a schematic overview of the system architecture of a second exemplary embodiment of the present invention;

FIG. 4 is an exemplary database schema for use with the tracking system of the present invention;

FIG. 5 is a user interface for receiving user information to create a user account with the tracking system;

FIG. 6 is a flowchart illustrating a method of initiating a lead and creating a lead record;

FIGS. 7 and 8 are user interfaces for interacting with an exemplary embodiment of the present invention to initiate a lead and create a lead record;

FIG. 9 is a user interface depicting an exemplary tracking system homepage; and

FIG. 10 is a user interface depicting an exemplary lead summary page.

### DETAILED DESCRIPTION OF THE EXEMPLARY EMBODIMENTS

Exemplary embodiments of the present invention will now be described in detail with reference to the aforementioned figures.

In one embodiment, the core tracking platform application is a server-based application comprised of core application modules for performing various core tracking functions operative with certain service modules for handling value added functionality and for communicating with ancillary services, such as calendars, e-mail, task/to-do lists, and the like. In this embodiment, a listing service tracking system comprises of one or more server systems capable of communicating with one or more database systems. The server systems and database systems are accessible by one or more end users via a network, such as the Internet. Each user of the tracking system is preferably pre-registered with the tracking system and has an account stored on the tracking system databases. When the user interacts with a listing service and initiates a lead, an initial lead record is created by the tracking system (or user depending on the particular application) and mapped to the end user's account in a lead database. The initial lead record stores pertinent information about the user's interaction with the particular online listing service that is the subject of that particular lead.

In another embodiment, the core tracking platform application is a downloadable, client-side application comprised of core application modules for performing various core tracking functions to capture a user's lead inquiries and create lead records. The tracking platform in this embodiment is operable on a user's computer. The user's computer is capable of communication with various listing services via a network, such as the Internet or the world wide web. Moreover, the user's computer is capable of communication with a tracking system server and database system, which, in turn, is in communicatively connected to one or more ancillary services, such as calendars, e-mail, task/to-do lists, and the like. The tracking system server and database system, in this embodiment, comprises programming to create and store user accounts, receive lead records from the user computer, associate the lead records to the appropriate user account, and integrate add-on services. The tracking system server and database system may further comprise programming to create and/or receive action records, as applicable, and associate the action records with the appropriate lead record stored in the leads database.

A lead can originate in many different ways, by way of non-limiting example: (i) initiating a job search with a particular employer, (ii) engaging a real estate agent to inquire about a particular property, and (iii) placing a bid for an item listed on an auction site. Although the exemplary embodiments will be described in connection with the above examples, persons of skill in the art will recognize that the present invention can be adapted to operate with any type listing service now known or hereafter developed.

Generally, when interacting with a listing service accessible via the world wide web, the user will be asked to enter certain information into an online form in order to initiate the inquiry. Based on the information entered by the user into the user inquiry interface, data about the inquiry can be captured and electronically transmitted to the tracking system so that a lead record can be dynamically generated. After an initial lead record is created under the user's account in the job leads database, a user is preferably given an opportunity to supplement the lead record with additional information pertaining to the lead that may have not been dynamically captured.

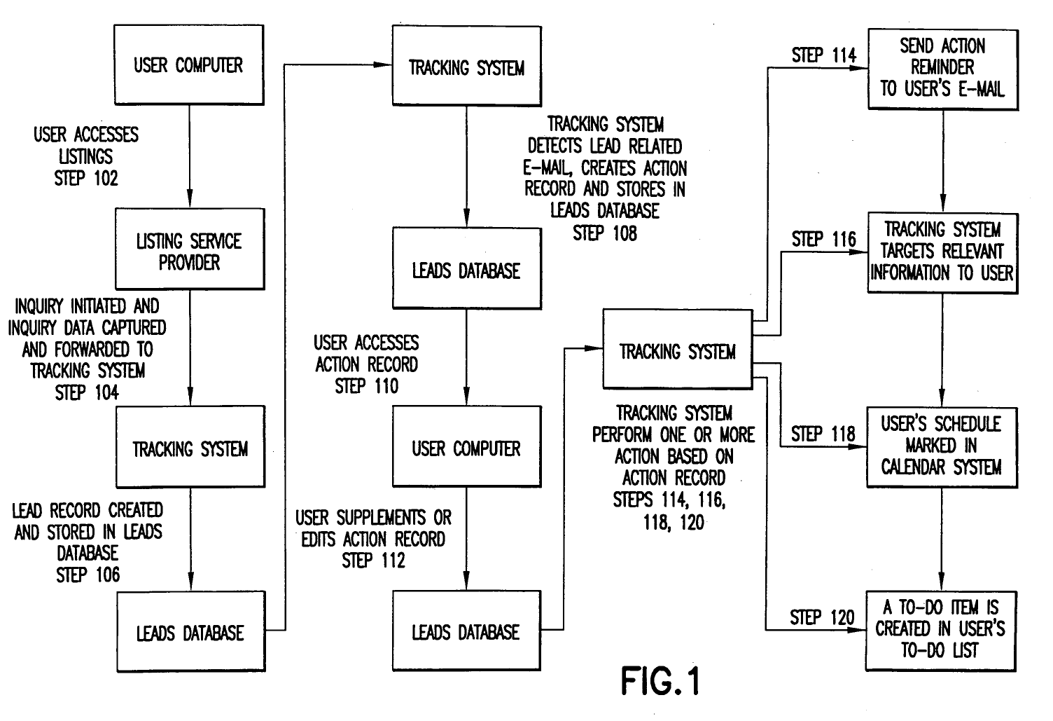

FIG. 1 is a data flow diagram illustrating an exemplary process of using the tracking system as a centralized hub to manage a lead. In the exemplary process of FIG. 1, the user uses a computer or other device with access to a listing service provider's site, in step 102, to browse and/or search the listings. If the user locates a listing that is of interest and commences an inquiry, then, in step 104, the data from the inquiry is captured and forwarded to the tracking system servers. Using the captured inquiry data, the tracking system application, which is operative on the tracking system servers, creates and stores a lead record on a lead database, in a step 106. The information associated with the lead, and stored in the lead record, is used to track the user's progress with an inquiry, log new actions, and provide value-added services to the user, as will be described further below.

Using the information stored in the lead record, the tracking system is capable of performing various functions to help the user track one or more leads. For example, if the user receives a lead related e-mail, the tracking system can be set to monitor the user's incoming e-mails to detect lead related e-mails. Using text analysis tools, such as keyword/key-phrase and/or an address recognition method, the tracking system identifies e-mails related to stored lead records, in step 108, and generates an action record using information in the lead related e-mail. The tracking system may be further programmed to notify the user of the e-mail, and may forward the all or a portion of the e-mail to a designated user device, such as the user's personal digital assistant (PDA). After creation of the action record, a user is given an opportunity to access the action record, in step 110, and supplement or edit the action record as necessary, in step 112. The updated action record is then stored on the leads database.

Using the action record, the tracking system may be programmed to perform one or more value-added functions to further aid the user in management of a lead. Thus, as shown in FIG. 1, in step 114, the tracking system may send a reminder to the user about the action. For example, if the action is an interview with a prospective employer, the tracking system will send a reminder e-mail to the user in advance of the interview. Further, as in step 116, the tracking system may target information related to the action record to the user either via e-mail or by posting the targeted information on the user's tracking system homepage. For example, if the action record relates to the purchase of a used car, the tracking system may post relevant car reviews, insurance information, and other car buying related information. Moreover, as in step 118, the tracking system may mark a user's calendar with the date of an event stored in the action record. In step 120, the tracking system may create a to-do item in the user's to-do task list, which may be posted on the user's tracking system homepage.

As will be described in further detail below, the exemplary tracking system permits a user to track one or more leads by using a lead and action record method and by integrating value-added ancillary services.

Exemplary System Architecture

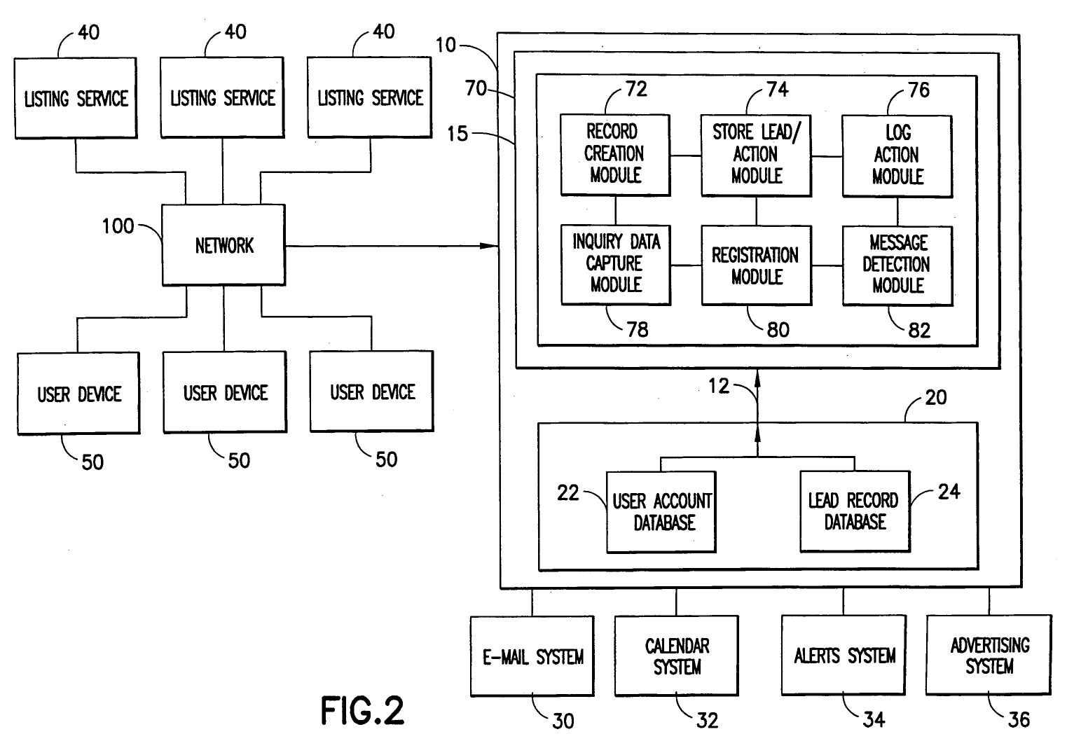

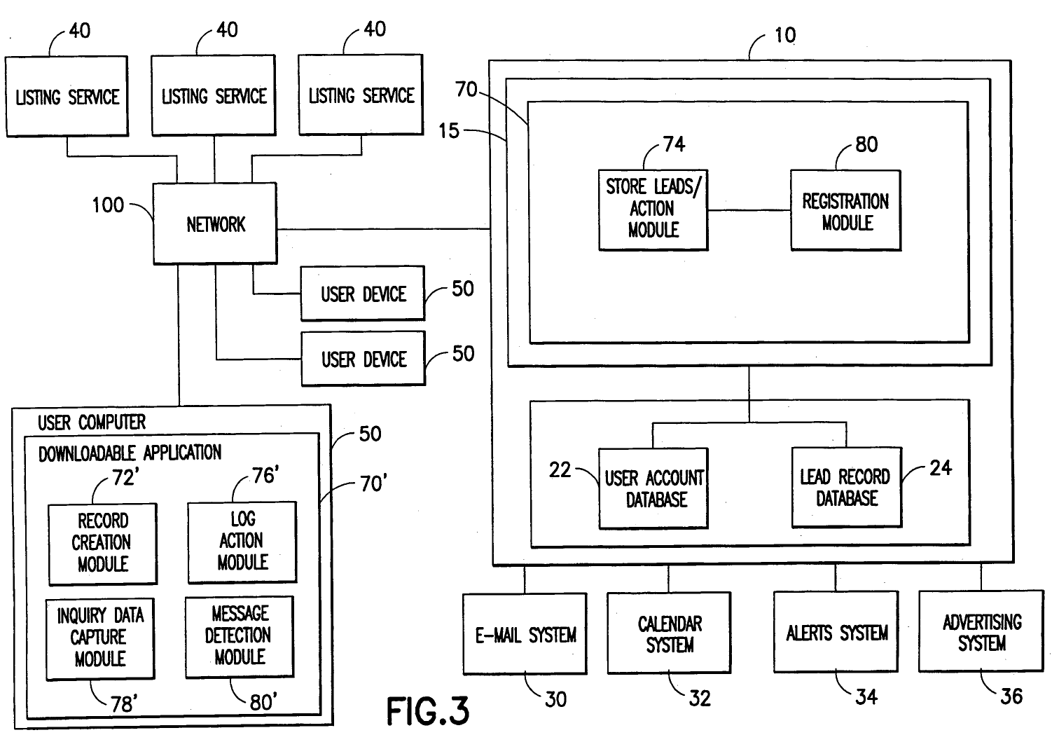

In exemplary embodiments of the tracking system 10, as shown in FIGS. 2 and 3, the tracking system 10 includes one or more servers 15 and storage devices 20 for storing the content and data that is distributed through the network to the end user devices. By way of example only, the servers 15 preferably include a processor, such as the Intel® Pentium® IV Xeon® processor or like processors, including the G-series of processors from Apple®, memory (RAM, ROM), clocks, and other components commonly included with server systems known in the art (not shown). The storage devices 20 may be any machine-readable storage medium now known or that will be known in the art, such as by way of non-limiting example, a hard disk, optical drive, or tape drive. The particular architecture of servers 15 and storage devices 20 is not critical to the invention.

Persons of skill in the art will recognize that such servers 15 and storage devices 20 may be locally connected or widely distributed. Moreover, although such servers 15 and storage device 20 are shown and discussed in the singular herein, persons of skill will recognized that any number of redundant or complimentary server and database systems may be utilized to effectuate optimum scalability and accessibility.

The listing service tracking system 10 is also capable of communicating with one or more electronic services, such as e-mail system 30, calendar system 32, alerts system 34, and advertising system 36, as well as communicating with one or more listing service providers 40 and one or more end user devices 50. In the exemplary embodiment shown in FIG. 1, the tracking system 10 is communicatively connected to electronic services, such as e-mail server 30, calendar server 32, alerts server 34, and advertising server 36 via a local area network (LAN) or wide area network (WAN) 38, as a matter of design choice. For example, the electronic services, such as 3-mail, may be provided by the same service provider or may be a remote external system operated by a separate service provider. In either case, the tracking system 10 is communicatively connected to such systems over a network. Similarly, although FIG. 2 depicts listing service providers 40 in communication with the tracking system 10 via a WAN or other network, such as the Internet, persons of skill will recognize that listing service providers 40 may be connected via a LAN such as may be the case when the entity operating the tracking system 10 and the listing service are the same. The network 100 is preferably a global network such as the Internet; although one skilled in the art will recognize that the network may be any communications network now known or that will be known that is capable of transmitting data, such as, for example, an intranet, local area network, wide area network, or other network using point-to-point protocols (PPP), wireless application protocols (WAP), satellite communication networks, and the like. As used herein, the terms “in communication with”, “communicatively connected to”, “capable of communication with”, and the like refers to systems that when connected to a network can transmit data to and receive data from other systems connected to the network, even if such systems are not always connected to the network and if the systems are not in direct communication, such as is the case with the Internet.

With further reference to FIG. 2, end user devices 50 for use with the present invention may include any type of personal or network computer having an operating system and, preferably, running a browser such as Microsoft Internet Explorer or Netscape Navigator. End user devices 50 generally access the network 100 to communicate with the tracking system 10. The user devices preferably, but not necessarily, include, by way of non-limiting example, a display (e.g., cathode ray tube (CRT) or liquid crystal display (LCD), etc.), and one or more input devices (e.g., a keyboard, mouse, touch pad, or light pen), and are capable of receiving and transmitting information to and from the tracking system 10. Such devices include a personal computer (pc), handheld (or pocket) pc, wireless telephone, tablet pc, personal digital assistant (PDA), and the like.

Content and information is communicated between the tracking system 10, service systems 32, 34, 36, 38, and end user devices 50, through network 100 and LAN and WAN networks 12 using, for example, TCP/IP and the hypertext transfer protocol (HTTP) in various known formats, such as, for example, HTML, DHTML, XML, scripting languages, and the like. Persons of skill will recognize, however, that other known or hereafter developed communication protocols may be utilized in connection within the scope of the present invention.

The Tracking Application

In a first exemplary embodiment, as shown in FIG. 2, the tracking system 10 components described above are operative with firmware and software to perform the functionality described herein. As shown in FIG. 2, a core tracking application 70 comprises one or more application modules, each for performing various functionalities as described herein. In the exemplary embodiment of FIG. 2, the tracking application 70 includes a record creation module 72, a log action module 74, an inquiry data capture module 76, a registration module 78, a message detection module 80 and a store lead/action module 82. The programming may be written in any known programming or scripting language, such as Java, JavaScript, C, C++, Visual Basic, VB Script, and other known and hereafter developed object oriented and non-object oriented programming languages.

For example, the tracking system may be composed in PHP and served using an Apache web server compiled with a PHP supporting module. The database could be constructed using MYSQL. All the user transaction pages (data entry, display, modification) would be presented in HTML as generated by the Apache server from the PHP templates. These pages in turn would create SQL queries to update information in the MySQL database. External systems such as email and calendaring would communicate via XML formatted requests to further PHP pages using the http post or other methods.

In another embodiment, as shown in FIG. 3, the core tracking platform application 70 is a downloadable, client-side application comprised of core application modules for performing various core tracking functions to capture a user's lead inquiries and create lead records. The tracking platform 70 in this embodiment is operable on a user's computer 50. The user's computer 50 is capable of communication with various listing services 40 via a network 100, such as the Internet or world wide web. Moreover, the user's computer 50 is capable of communication with a tracking system server 15 and database system 20, which in turn is communicatively connected to one or more ancillary services 32-38, such as calendars, e-mail, task/to-do lists, and the like. The tracking system server 15 and database system 20, in this embodiment, comprises one or more application modules to create and store user accounts, receive lead records from the user computer, associate the lead records to the appropriate user account, and integrate add-on services. The tracking system server 15 and database system 20 may further comprise programming to create and/or receive action event, as applicable, and associate the action events with the appropriate user account.

Thus, by the foregoing, it will be understood by persons of skill in the art that the tracking application 70, which consists of one or more modules, may reside wholly or partially on the tracking system 10 or on a user's computer 50 as a downloadable application, as a matter of design choice. However, it is presently believed that it is preferable that the tracking application 70 be operative solely on servers 15.

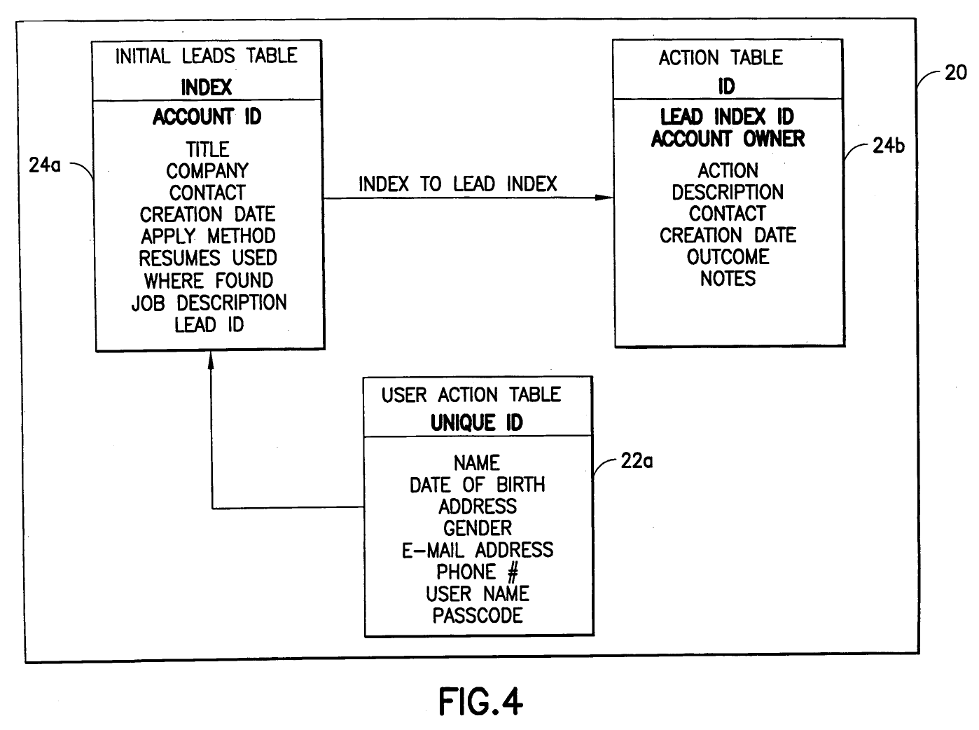

An exemplary database schema for the lead database 20 is shown in FIG. 4. With further reference to FIGS. 2 and 3, database 20 comprises a user account database 22 and a lead record database 24. The user account database 22 stores information relating to the user, such as, but not limited to, first and last name physical address, e-mail address(es), telephone numbers, account and pass code information, and date of registration. Upon registration, the user account may be assigned a unique user identifier that will be associated with the information in the user account. For instance, the user identifier will be associated with the user name such that when the user is logged in to the tracking system, the tracking system can more easily associate lead and action information with the user's account. The unique user identifier is also used by the alert and advertising systems 34, 36 to direct related news, notices, and advertisements to the user, as described below.

Further, as shown in FIG. 4, an initial leads table 24a of the lead record database 24 stores information related to the initial lead inquiry, such as, by way of non-limiting example, lead title, contact information, creation date, listing service provider, and other lead specific information. For instance, if the lead relates to a job search inquiry, the lead table 24a might store the employer's name and address, job application method, resumes used to apply, and the job description. It will be understood by persons of skill in the art that the type of information stored in the leads table 24a may be tailored to fit the types of lead inquiries that the tracking system may be designed to operate with. Moreover, multiple lead record templates for various listings may be used and selected from as needed.

Action record table 24b stores information related to lead actions. The action concept will be described in further detail below; however, an action record generally permits the user to record events (past, present, or upcoming) that are related to their lead inquiry. The action table 24b may store an associate with the lead record, account owner information, action type, action description, contact information, creation date, outcome of the action and notes. The action type field may be selected from one or more preset action types related to a type of lead. For instance, if the lead relates to a job search, the action types may include, but are not limited to, the following: telephone call, interview, call back interview, follow-up, offer extended, and offer accepted/declined. It will be understood by persons of skill in the art that the type of information stored in the action table 24b may be tailored to fit the types of lead inquiries that the tracking system may be designed to operate with. Moreover, multiple action records templates for various listings may be used and selected from as needed.

User Account Registration

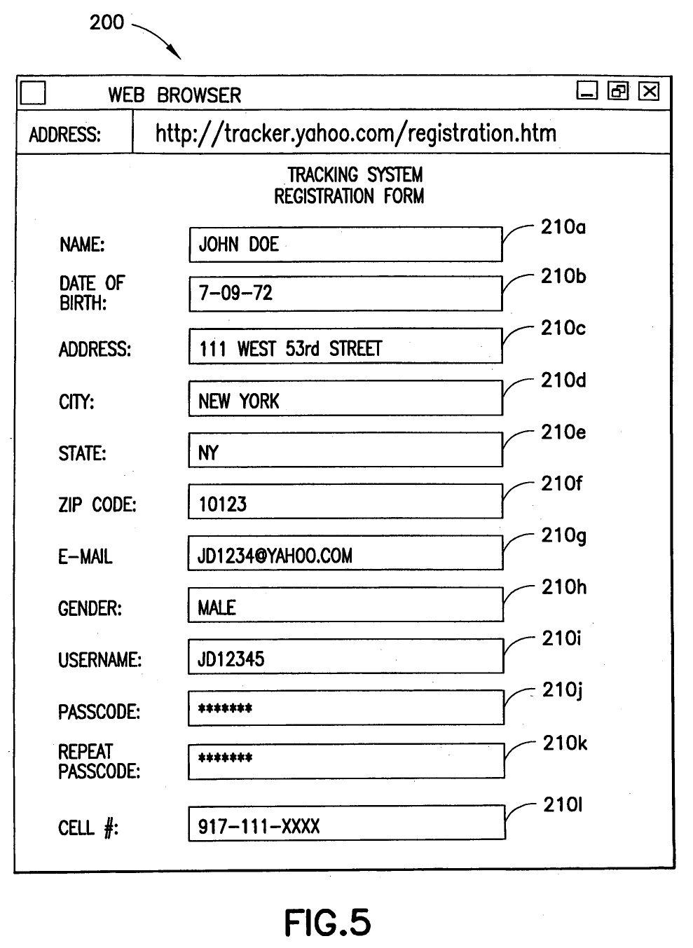

In an exemplary embodiment, prior to utilizing the tracking system 10, a user registers with the tracking system 10 by inputting certain user information into a user registration form 200, which may be made available via the Internet or world wide web. The registration form 200 and the account registration process described herein are controlled by registration module 80. The user registration form 200 is used to collect information about the user such as the user's first and last name, user's physical address, including city and state of residence, an electronic address, telephone number, the user's gender, age, and other such information. Registration form 200 is preferably a web-based form having input boxes for entry of the user information as shown in FIG. 5 by input boxes 210a-210l. Persons of skill will recognize that in addition to input boxes any type of input field, such as check boxes, radio buttons, drop down menus, and the like.

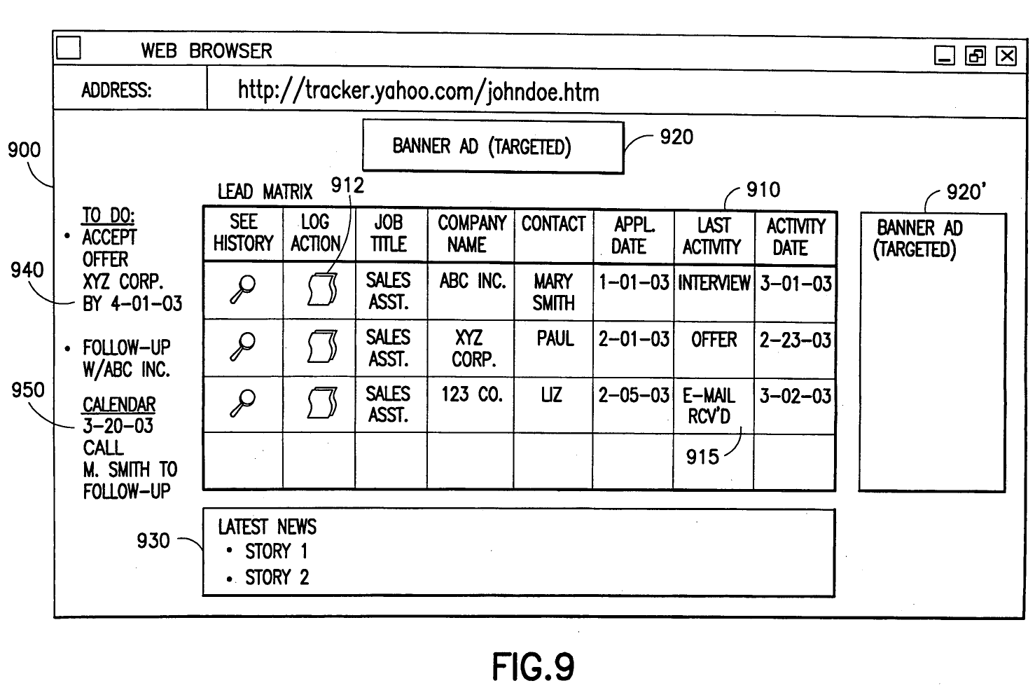

Upon transmission of this information to the tracking system, a registration module 80 creates an account for the user on the leads database and prompts the user for a user name and pass code for use with the tracking system 10. The registration module 80 maps the associated login information with the user's account stored on the leads database. At this point, the user may be notified by the tracking system 10 that the registration process is completed and the user may be directed to a tracking system home page, as shown and described in connection with FIG. 9 below. The registration module 80 may further deposit a cookie on the user's system that remembers the user's user name and task code and is capable of storing other information related to usage of the tracking system. Prior to initiating a search or browse session on a particular listing service, it is preferred that the user login to the tracking system 10 so that the tracking system 10 can monitor the initiation of any lead inquiries.

Lead Initiation and Lead Record Creation

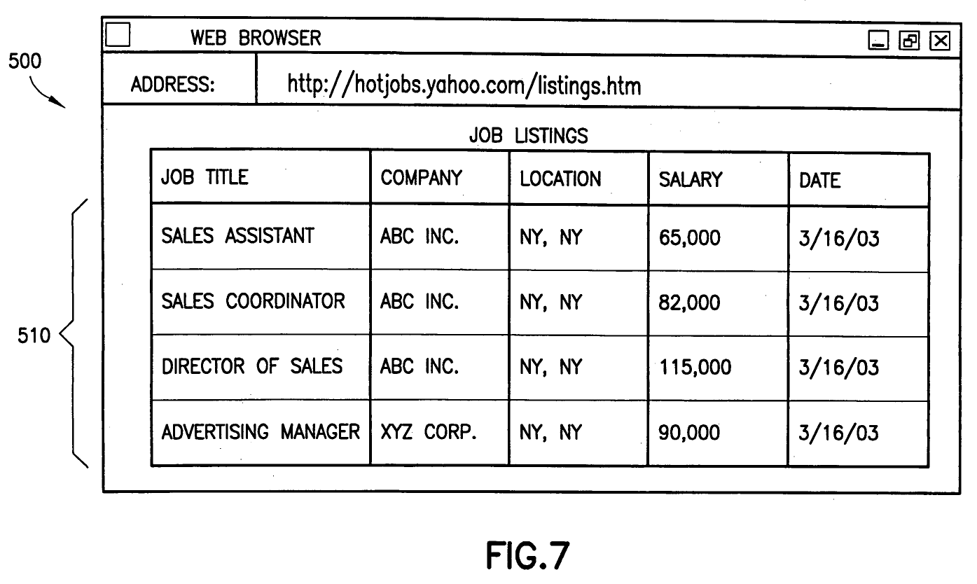

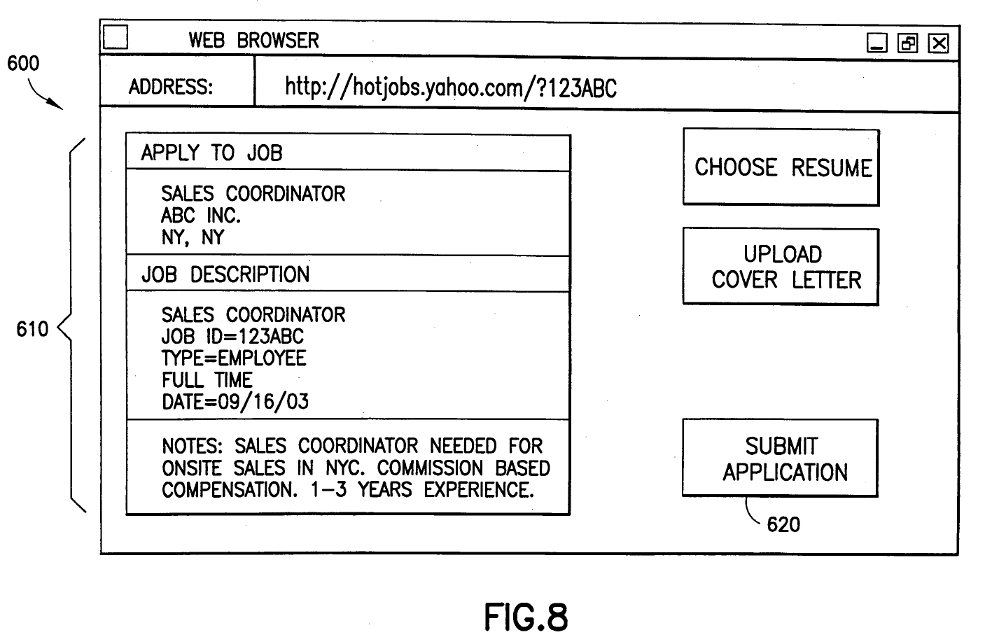

With reference now to FIG. 5, an exemplary method of lead initiation and lead record creation is shown. Further, with reference to FIGS. 7-8, exemplary graphical user interfaces (GUIs) to facilitate the user's interaction with the tracking system 10 are shown. By way of example only, an exemplary method 600 of lead initiation and lead record creation will be described in connection with the initiation of a job search and contact with a prospective employer.

In step 602, the user may browse various job listings on a web site providing such listings, such as the HotJobs® web site. The user's browsing may be initiated through selection of a category of job/employer or via a search performed on the job-listing site. FIG. 7 depicts and exemplary interface 700 having a number of job listings 710 that may be presented to a user in response to a search request. The particular method used to search within the listing service is not critical to the present invention. In step 604, the user selects one of the listings to initiate a job lead and is presented with a job application interface 800 as shown in FIG. 8. The job application interface preferably includes information 810 pertaining to the job and permits the user to enter information about him- or herself, including but not limited to the creation of a cover page and selection of a resume. Upon completion of the application, the user may submit the application by, for example, clicking on a “submit application” button 820 or via other such action.

The action triggers a call to a record creation module 72, which commences lead record generation functionality. If the user has not already registered, the user may at this point be prompted to register with the system as described above as a value-added service.

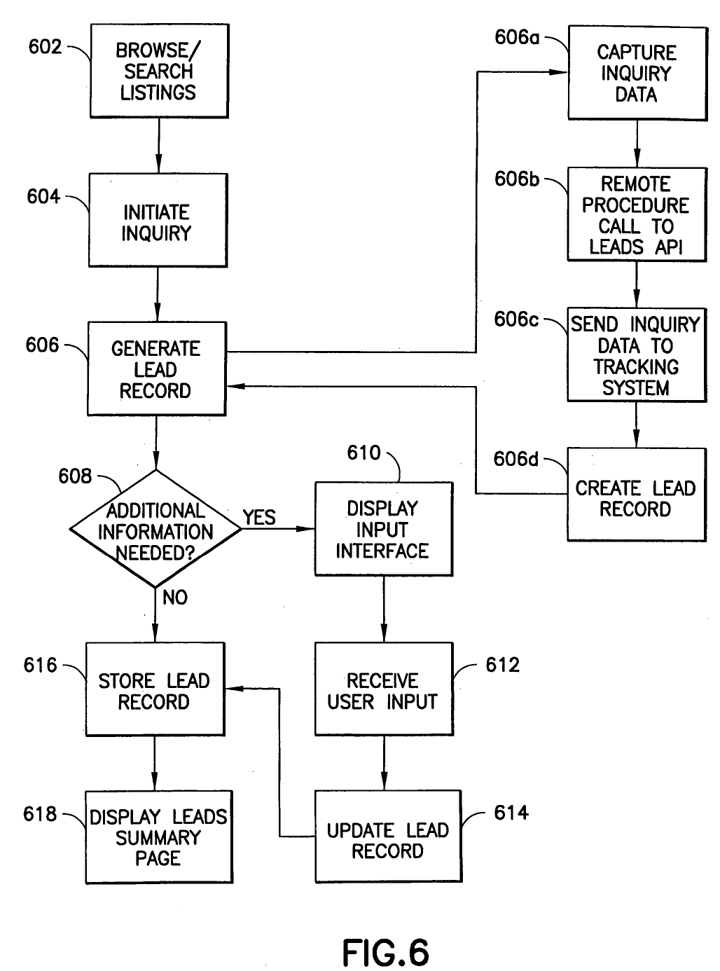

Referring again to FIG. 6, in step 606, the tracking system 10 dynamically generates a lead record. Steps 606a to 606e further describe an exemplary embodiment of the lead record generation process as controlled by record creation module 72. In one embodiment, as in step 606a, the listing service system 40 captures the inquiry data upon submission or commencement of the inquiry (e.g., in the example above, clicking the “submit application” button). For example, a job listing service would often capture information about an applicant before or during the hire. This information could be name and address information, resume information, etc. In order to transmit the application to the employer, most of this information is made accessible to the apply component of the listing service. By partnering with the listing service, an exchange of data (via XML request, for example) could be arranged resulting in a transmission of inquiry data to the listing tracking application during the application process. In another application, the URL of the job list could be entered by the user into a lead creation page on the listing tracking application server. A lead harvesting component would then parse the page displayed by the URL and extract inquiry information (such as company name, job title, job description, etc.). By way of example, the inquiry data would preferably, but not necessarily include pertinent information about the job application such as the company name, job title, job description, resume version used, date of application, a copy of the initiating cover letter or message, and the like. In the present exemplary embodiment, as in step 606b, the listing service system would then make a remote procedure call to an application programming interface (API) exposed by the tracking system 10 and, in step 606c, transmit the captured inquiry data to the tracking system 10. In step 606d, the tracking system 10 creates a lead record for insertion into the lead record database 24.

In an alternate exemplary embodiment, as shown in FIG. 3, wherein the tracking system 10 embodies a downloadable or plug-in application that runs in the background of a user's browsing session, the tracking system 10 applet/plug-in would capture the inquiry data upon the submit application action and create a lead record for insertion into the lead database 20 as in step 606a. In a client-side plug-in form, the tracking system could capture information for lead creation from a browser using any technology that would have access to information parsed by the browser. For example, the listing tracker service could be integrated into the Yahoo!® Companion toolbar, as disclosed by U.S. patent application Ser. No. 09/429,585; the entire disclosure of which is incorporated herein by reference. In this case triggering “lead creation”, by, for example, clicking a create lead button on the Yahoo!® Companion toolbar, would parse the displayed webpage for information to populate an initial lead. In the case of a job, the apply page for the job could be parsed to extract the job title, company information, etc. Additional information could be captured from the user's computer (e.g., system date for date of submission). The user could also be immediately prompted in a pop-up window for more information not found on the displayed page. In this embodiment, there would be no need for the tracking system to expose an API to the listing service system 40 or for the listing service system 40 to make a remote procedure call, as per step 606b of FIG. 4.

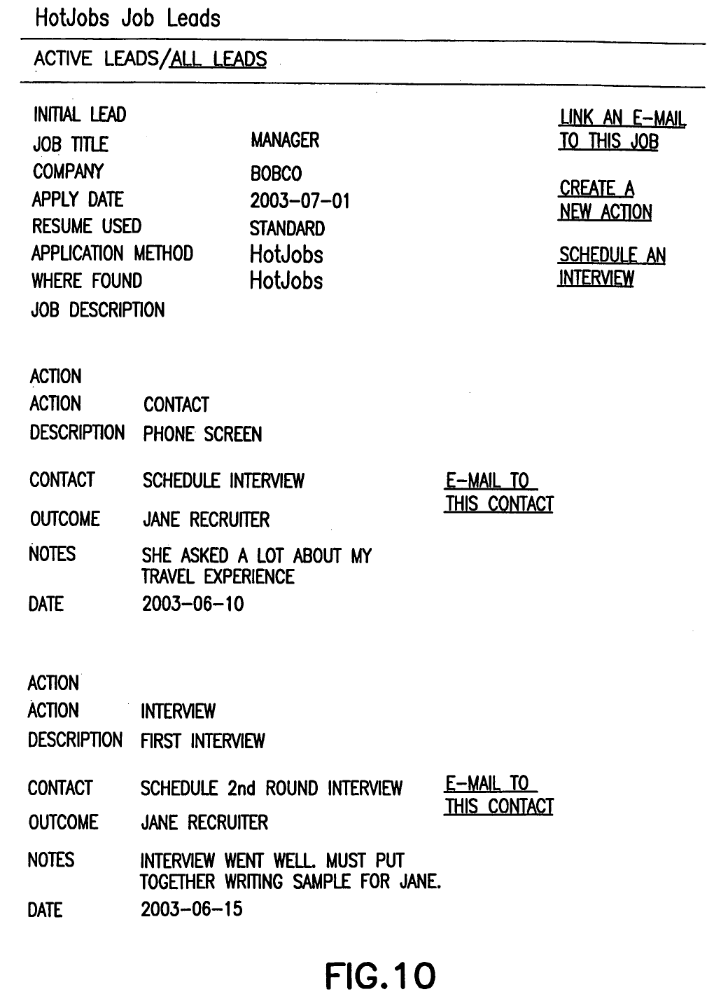

Next, in step 608, the user may be prompted to input additional information to the lead record. If the user indicates that he/she would like to enter additional information, the user is presented with an input interface in step 610. In step 612, the user transmits the additional information, which is received by the tracking system 10. The tracking system 10 then updates the lead record and stores the updated lead record, in steps 614 and 616, using store lead/action module 74. Next, in step 618, the user is may be presented with a summary interface. An exemplary summary interface is shown in FIG. 10.

Once the initial lead record is created and stored is serves as the focal point for the management of actions related to the lead. As will be described in further detail below, the lead record may contain information from which several actions by the tracking system 10 and associated ancillary e-services can be triggered. For example, using the lead record, news stories pertinent to the prospective employer can be directed to the user's e-mail account or posted on a home page displaying the user's leads. By way of further example, the tracking system use an agent or other type of program, such as a web-bot, robot or crawler, to perform a search for additional, relevant positions that may be posted on one or more listing services.

The tracking system 10 can also be adapted to operate with alert system 34. As shown in FIGS. 2 and 3, alerts system 34 is communicatively connected to the tracking system 10. Alerts system 34 provides notification of information to users when certain user-selected criteria are met or when a match is made between the user's selected criteria and information contained in a source or feed to the alerts system 34. The system 34 allows the user to register a set of long-standing or persistent queries, which represent the user's interests. Whenever new information becomes available, the information is matched against all user queries and the appropriate information will be delivered to each individual user substantially in real-time or on a predefined schedule.

The following is a description of the exemplary process used to create an alert in the alerts system 34. When the end user creates a lead or action record, information from the lead/action record is used to configure the alert. In the case of news alerts, for example, key words or phrases taken from the lead/action record, such as any news reports that contain the name of a prospective employer, are used to configure the alert. The end user then selects his or her desired method of notification, such as an e-mail or a portable device, e.g., a text-enabled cell phone or a personal digital assistant (PDA). Preferably, during the registration process, the end user has input information relating to their available portable, wireless devices. This information, e.g., the e-mail address or cell phone number, is exported from the tracking system 10 to the alert system 34. For verification purposes, alert system 34 may sends a code to the portable device of the user which must be entered into alerts system 34 to ensure that alerts are only sent to those persons that specifically request them. When a match is made, an alert is sent out to the user's selected method of notification.

By way of example, a user who is interacting with a personals listing site may wish to have an alert anytime one or more personal ads match their criteria. A personals alert may also be forwarded to the user when someone sends the user a message through the personals listing service.

Moreover, advertising can be targeted to the user based on the information stored in one or more lead records created by the user. For example, if the user has been initiating job inquiries with advertising firms, that information will be reflected in the lead record by at least the job type field. Based on this information, the advertising system 36 can target ads to the user, by way of non-limiting example such as ads for design schools, computer graphics classes, or general business schools.

FIG. 9 depicts an exemplary home page interface that can be presented to a user upon login to the tracking system. The exemplary home page interface 900 shown in FIG. 9 includes a lead matrix 910, one or more advertisements, such as banner ads 920, 920′, news listings 930, and to-do and calendaring sections 940, 950. Persons of skill will recognize that the depicted interface and its components are merely illustrative and any number or combination of features can be incorporated into the home page as a matter of design choice. For example, any ancillary electronic service, including but not limited to the services described herein, can be included within the home page interface.

### OPERATIONAL EXAMPLES

1. Job Listings

As discussed above, upon creation of a lead record, the tracking system 10 uses the lead record to trigger events and track various user actions. The following is a description using the job search illustrative of exemplary events and actions that may occur during the job search and for which the tracking system 10 provides functionality.

At some point after initiation of the job search, as described above, the user may receive an e-mail from the listing service or an employer arranging an interview. Because the user's e-mail system is linked to the tracking system 10, the tracking system 10 can detect e-mail related to the user's leads and either forward such e-mails to the user's account or indicated in some manner that an e-mail was received and that the user should check their e-mail account. For example, the exemplary interface of FIG. 9 shows an indication that the user has received an e-mail in lead record 915. Of course, any indication may be used within the scope of the invention.

The tracking system 10 may utilize keyword/key-phrase detection to identify e-mails relevant to a particular lead. In such a system, the e-mail system 30 would permit a message detection module 82 of the tracking system 10 to access the address, subject, and body text from e-mails received into the user's e-mail account. The detection module 80 would use keywords/key-phrases from the user's lead records, such as the employer name, job type, job id, employer contact name, and the like, to determine whether the e-mail is likely to be relevant to a particular lead record. If it is, then the detection module 80 adds an indication to the lead record which will be displayed to the user the next time the user logs in to their tracking system account. The indication or e-mail itself may also be forwarded to any of the user's computing devices 50 by the alert system 34, as described in greater detail above. For instance, an indication that an e-mail has been received may be forwarded to the user's wireless phone or PDA or handheld device.

Alternatively, or in addition to a keyword/key-phrase method, the detection module 82 can utilize designated e-mail addresses to detect relevant e-mails. For example, the detection module 82 can use the domain name (e.g., [name]@company.com) to detect relevant e-mails. The user may also be prompted to add the employer's e-mail to his/her address book and link the newly created address book record with the lead record. Future e-mails from the employer's e-mail account associated with the address book record will automatically create contact activities under in the lead record. Information about the activity (e.g., that it was an e-mail, who it came from, the date, and contents of the message) will be automatically logged by the tracking system 10. In this way, the tracking system serves as a centralized repository of information related to the lead. Thus, if the user receives an email from “abcinc.com”, the detection module 80 will identify the e-mail as relevant. Persons of skill will recognize that various detection schemes and combinations of the same may be utilized within the scope of the present invention.

In response to the e-mail, the user can create an action under the initial lead record using an interface of the tracking system 10. The interface and the action record functionality is controlled by a log action module 76 operative of the tracking system 10 and may be triggered, for example, upon a user input (e.g., a click on the log action icon 912), as shown in FIG. 9. The interface 900 may be web-based or made available on any of the user's computing devices 50; for example, an interface on a PDA. The tracking system 10 creates an action record as a child of the lead record in leads database 24. The action record stores information about the action (e.g., the job the action relates to, the date, a summary of the action, the contact associated with the action, notes, etc.).

To the extent the action record requires some action in the future, the log action module 76 of the tracking system 10 may, as applicable, dynamically populate the user's calendar or to-do list with the date of the future action. For example, if the future action is a follow-up with a prospective employer or an interview date, the action module will populate the user's calendar and/or to-do list with the action.

In turn, the log action module 76 may transmit the user account id and other information about the action (e.g., that the reminder is about an interview with a particular prospective employer) to the alerts system 34 so that a reminder email can be forwarded to the user. The alerts system then retrieves the user's selected method of notification and formats the information received from the tracking system top generate the alert. At some predefined time prior to a scheduled action, such as an interview, the tracking system 10 will send a reminder e-mail to the user's designated e-mail account. This e-mail reminds the user of the date, time, and location of the interview, may suggest that they review their previous activities relating to the lead record, and may offer supplementary information, as appropriate. For example, the tracking system 10 may include a copy of the resume the user used in the initial application, a copy of the job description, a map showing the address of the interview location, and links to recent news items regarding the company offering the position. Because, in the present example, the action is an interview, the following day, the tracking system 10 would preferably send a post-action reminder e-mail to the user reminding them to send a follow-up with the recruiter/interviewer.

If the interview goes well, and the user receives an e-mail from the recruiter indicating that the employer would like to extend an offer. The log action module 76 of the tracking system 10 would dynamically create an additional action record under the lead record. At this point, the next time the user logs into their tracking system account, he/she will be prompted to create a concluding action. The concluding action preferably records the date and terms of the offer, such as proposed salary, start date, title, signing bonus, etc. When the user indicates that he/she has accepted the offer, the lead record will be closed.

2. Real Estate Listings

An exemplary embodiment of the tracking system 10 adapted to track a user's interactions with real estate listings will now be described. In this embodiment, a lead table would include fields to store information tailored to track real estate inquiries including, but not limited to, the Multiple Listing Service (MLS) listing number, description of the property, agent name, agent contact information, record creation date, and listing site name. Further, in this embodiment, an action table would be customized to support real estate related inquiries. Such an action table may include action type field for storing the type of action (e.g., open house, offer, counter-offer, walkthrough, closing date, etc.), date and time of the action, location, agent name and information, and the action creation date.

By way of example, after initiation of an inquiry and creation of a lead record, a user may receive an e-mail from a real estate agent regarding the property that is the subject of the inquiry. This event will trigger the creation of an action record either dynamically or manually, as described above. During the inquiry process, the user's tracking system homepage may be populated with value-added information, such as similar listings, inspection services, mortgage offers and analysis tools, and neighborhood and school district research tools. The user's homepage would also preferably be populated with reminders relevant to the user's real estate lead record. Thus, for example, if the user is approaching closing, the tracking system may forward reminders to the user pertaining to home inspections, moving company arrangements, and the like. Such reminders may also be e-mailed to the user or structured as alerts.

In addition, the tracking system 10 may be adapted to simultaneously track both the buy-side and sell-side of a real estate transaction. Thus, the tracking system 10 can be adapted to help a user deal with the complex scheduling and organizational issues inherent in a move from one house to another. In such an embodiment, a user may first create a lead record including information about the user's property. This lead record, which will be referred to for purposes of this discussion as “Lead Record R1,” will form the central record for all actions concerning the user's home. During creation of Lead Record R1, the user will have an opportunity to link Lead Record R1 to an existing real estate lead record. Assuming that no records exist, and the user later initiates an inquiry, the user at that time will again be prompted to link the new real estate lead record (referred to as “Lead Record R2”) to Lead Record R1. To facilitate linking, the real estate record may generally include a linked to field, which will identify the record to which a particular lead record is linked. By tracking actions pertaining to Lead Record R1 along with actions pertaining to Lead Record R2, the user will be able to better plan events and more efficiently bring both transactions to closing.

3. Personal Listings

An exemplary embodiment of the tracking system 10 adapted to track a user's interactions with personal and social network listings will now be described. As mentioned in the background of the invention a goal of web site owners is to increase user retention/affinity for their site by providing the user with interesting and useful tools. Additionally, it is a goal of such web site owners to couple increased user affinities to their sites with affinities between users. Personal and social network listings partly serve this objective by bringing users of a web site together and providing a platform for these users to communicate. The exemplary tracking system 10 further serves this objective by providing networked users with a platform through which these users can track and organize their various contacts.

In this embodiment, a lead table would include fields to store information tailored to track personal/social network listing inquiries including, but not limited to, a user profile identifier contact information, record creation date, and listing site name. Further, in this embodiment, an action table would be customized to support personal/social network related inquiries. Such an action table may include action type field for storing the type of action (e.g., first date, friends get together, first contact, matching profile found, etc.), date and time of the action, location, and the action creation date. The tracking system would operate as described above.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

1. A method of tracking a user's interaction with a listing service, the method comprising:
receiving inquiry data related to an initial inquiry of the user with the listing service;
creating a lead record using the received inquiry data;
storing the lead record in a database;
creating an action record associated with the lead record each time data related to an action to be taken in furtherance of the initial inquiry is received;
storing the action record in the database; and
populating an interface accessible by the user with information stored in the lead and action records, and with information related to the initial inquiry received from one or more ancillary services.

2. The method of claim 1, wherein the listing service is a web site having job postings listed thereon.

3. The method of claim 1, wherein the listing service is a web site having personal ads listed thereon.

4. The method of claim 1, wherein the listing service is a web site having real estate postings listed thereon.

5. The method of claim 1, wherein the listing service is a web site having automobile postings listed thereon.

6. The method of claim 1, wherein the listing service is a web site having auction items listed thereon.

7. The method of claim 1, wherein the ancillary service is electronic mail.

8. The method of claim 1, wherein the ancillary service is an advertising system.

9. The method of claim 1, wherein the ancillary service is a road navigation system.

10. The method of claim 1, wherein the ancillary service is a news system.

11. The method of claim 1, wherein the step of receiving inquiry data related to an initial inquiry of the user with the listing service further comprises:
receiving inquiry data from an application operative on a computing device of the user.

12. The method of claim 1, wherein the steps of receiving inquiry data related to an initial inquiry of the user with the listing service and creating a lead record using the received inquiry data further comprise:
receiving inquiry data from a user computer at the listing service;
capturing the inquiry data at the listing service;
making a remote procedure call to access an application programming interface from a listing service to a tracking system operative with programming to generate a lead record;
transmitting the inquiry date to the tracking system from the listing service; and
creating a lead record using the received inquiry data.

13. A method of tracking a user's interaction with a listing service, the method comprising:
receiving inquiry data from a user computer at a listing service;
capturing the inquiry data at the listing service;
making a remote procedure call to access an application programming interface from a listing service to a tracking system operative with programming to generate a lead record;
transmitting the inquiry date to the tracking system from the listing service;
creating a lead record using the received inquiry data;
storing the lead record in a database;
creating an action record associated with the lead record each time data related to an action to be taken in furtherance of the initial inquiry is received;
storing the action record in the database; and
populating an interface accessible by the user with information stored in the lead and action records, and with information related to the initial inquiry received from one or more ancillary services.

14. A system for tracking a user's interaction with one or more listing services, the system comprising:
a server system accessible via one or more networks by one or more computing devices of a user and capable of communicating with the listing services via one or more of the networks;
a database system in communication with the server system;
wherein the server system includes programming to receive lead data from the listing services, generate a lead record, and store the lead record in the database system;
wherein the serving system further includes programming to generate a user interface accessible to the user that displays a summary of the user's stored lead records;
wherein the server system further includes programming to interact with at least one ancillary service system and provide information generated or received into the ancillary service system to the user; and
wherein the server system further includes programming to receive action data, generate an action record, store the action record in the database system, and provide information about the action record to the user.

15. A tracking system application for tracking a user's interactions with a listing service, the application comprising:
a client-side component operative on a user computer capable of monitoring a user's interaction with the listing service so as to capture inquiry data and electronically communicate the inquiry data via a network;
a server-side component operative on a server system capable of communication with the network, the server-side component including programming to:
generate a user interface accessible to the user that displays a summary of the user's stored lead records;
interact with at least one ancillary service system and provide information generated or received into the ancillary service system to the user; and
receive action data, generate an action record, store the action record in the database system, and provide information about the action record to the user.
